(19) United States
(12) Patent Application Publication
(10) Pub. No.: US 2024/0228214 A1
(43) Pub. Date: Jul. 11, 2024

(54) Electrode Running Roller and Notching Device Comprising the Same

(71) Applicant: LG Energy Solution, Ltd., Seoul (KR)

(72) Inventors: Younghak Lee, Daejeon (KR); Jun Wan Kim, Deajeon (KR); Hak Sik Lee, Deajeon (KR)

(73) Assignee: LG Energy Solution, Ltd., Seoul (KR)

(21) Appl. No.: 18/285,744

(22) PCT Filed: Aug. 31, 2022
(86) PCT No.: PCT/KR2022/013005

§ 371 Date: Oct. 5, 2023

(30) Foreign Application Priority Data
Aug. 31, 2021 (KR) 10-2021-0115349
Aug. 30, 2022 (KR) 10-2022-0109300

(51) Int. Cl. B65H 27/00; H01M 4/04

(52) U.S. Cl. CPC B65H 27/00; H01M 4/0404; H01M 4/0435; B65H 2404/13171; B65H 2511/11; B65H 2701/173; B65H 2701/19

(57) ABSTRACT

The present invention provides an electrode running roller which causes an electrode sheet in which a current collector is coated with an electrode active material to run, wherein the running roller includes a cylindrical section, and a tapered section extending from one end portion of the cylindrical section, and the tapered section has a shape in which an outer diameter gradually decreases toward a distal end portion of the tapered section.

### CROSS-REFERENCE TO RELATED APPLICATIONS

This application is a national stage entry under 35 U.S.C. § 371 of International Application No. PCT/KR2022/013005, filed on Aug. 31, 2022, which claims priority to Korean Patent Application Nos. 10-2021-0115349, filed Aug. 31, 2021, and 10-2022-0109300 filed on Aug. 30, 2022, the disclosures of which are incorporated herein by reference in their entireties.

### TECHNICAL FIELD

The present invention relates to an electrode running roller and a notching device comprising the same.

### BACKGROUND ART

With increasing technological development and demand for mobile devices, a rechargeable secondary battery is widely used as energy sources for various mobile devices. In addition, the secondary battery is attracting attention as an energy source for an electric vehicle, a hybrid vehicle and the like, which are proposed as a solution to air pollution caused by existing a gasoline vehicle and a diesel vehicle.

The secondary battery is classified into a coin-shaped battery, a cylindrical battery, a prismatic battery, and a pouch-shaped battery according to the shape of the battery case in which the electrode assembly is incorporated. In general, the electrode assembly incorporated in the battery case is classified into a jelly-roll type in which a separation membrane is interposed and wound up between an anode and a cathode, a stack type in which a plurality of unit cells with the separation membrane interposed between the anode and the cathode are stacked, and a stack/folding type in which the unit cells are wound with a separation film.

Such a secondary battery can be manufactured by coating an electrode mixture, which is a mixture of an electrode active material, a conductive material, a binder, etc., on an electrode current collector and then drying it to manufacture an electrode, laminating the manufactured electrode together with the separation membrane to form an electrode assembly, and then embedding and sealing in a battery case together with an electrolyte. The electrode assembly is classified into a stack type, a folding type, a stack-folding type, etc. depending on the manufacturing methods. In the case of a stack type or stack-folding type electrode assembly, the unit assemblies have a structure in which an anode and a cathode are sequentially laminated with a separation film interposed therebetween. In order to manufacture such an electrode assembly, it is first necessary to manufacture the anode and the cathode having electrode tabs formed thereon.

That is, in order to manufacture a unit electrode having electrode tabs, first, a notching process is required to form the electrode tabs on a continuous electrode sheet coated with an electrode active material on one or both sides thereof. The notching process generally consists of a process of placing an electrode sheet on a die and punching out a part of the electrode sheet using a press. Here, the electrode sheets are conveyed by running rollers that run in synchronism with the operation of the press, and are sequentially punched to form electrode tabs.

The surface of the electrode sheet is made up of a coating portion coated with an electrode active material, and a non-coating portion coated with no electrode active material, and the running roller is formed in a cylindrical shape. The electrode sheet moves in close contact with an outer peripheral surface of the running roller. When the electrode sheet runs on the running roller, since the coating portion and the non-coating portion on the surface of the electrode sheet have different coefficients of friction, a difference occurs in a tension with the roller. Therefore, there are problems such as breakage of the non-coating portion and breakage at the boundary between the coating portion and the non-coating portion.

Therefore, there is a great need for a technology that can solve the above problems.

### PRIOR ART DOCUMENT

### Patent Document

Korea Registered Patent No. 10-1759570

### DISCLOSURE

### Technical Problem

An object of the present invention is to provide an electrode running roller that can solve the problem of occurrence of breakage at the boundary between a coating portion and a non-coating portion of an electrode sheet, when the electrode sheet is conveyed by the running roller.

Another object of the present invention is to provide a notching device comprising the running roller.

### Technical Solution

In order to achieve the above object, the present invention provides an electrode running roller which causes an electrode sheet in which a current collector is coated with an electrode active material to run, wherein the running roller comprises a cylindrical section, and a tapered section extending from one end portion of the cylindrical section, and the tapered section has a shape in which an outer diameter gradually decreases toward a distal end portion of the tapered section.

In an embodiment of the invention, a ratio of the length of the cylindrical section to a length of the tapered section may be 4:1 to 1:1.

In an embodiment of the invention, the tapered section may have a truncated conical form.

In an embodiment of the present invention, the tapered section may form an outer peripheral surface inclined at an angle of 0.2 to 0.5 degrees toward a central axis on the basis of an outer peripheral surface of the cylindrical section.

In an embodiment of the present invention, the electrode sheet may have a coating portion coated with an electrode active material, and a non-coating portion not coated with the electrode active material, and the electrode running roller may be disposed such that the non-coating portion is positioned in the tapered section.

In an embodiment of the present invention, the electrode running roller may be disposed such that the coating portion of the electrode sheet is positioned at a boundary between the cylindrical section and the tapered section.

In an embodiment of the present invention, a portion of the electrode sheet, except the non-coating portion, may be in contact with the outer peripheral surface of the cylindrical section.

Also, the present invention provides a notching device for forming an electrode tab on a continuous electrode sheet in which an electrode active material is coated on one side or both sides of a current collector in a manufacturing process of a battery cell.

The notching device comprises:
a press which punches the electrode sheet so that the electrode tab may be formed on a part of the electrode sheet;
a die formed with an opening having a shape corresponding to the press so that a scrap punched by the press can be discharged; and the electrode running roller of the present invention which conveys the electrode sheet to the press in synchronization with the operation of the press.

### Advantageous Effects

The electrode running roller of the present invention includes a tapered section extending from one side end of a cylindrical section, and by disposing the non-coating portion of the electrode sheet in the tapered section, it is possible to reduce breakages that occur at the boundary between the coating portion and the non-coating portion of the electrode sheet when the electrode is running.

### DESCRIPTION OF DRAWINGS

FIG. 1 is a perspective view showing an electrode running roller according to an embodiment of the present invention.

FIG. 2 is a cross-sectional view of the electrode sheet.

FIG. 3 is a perspective view showing a conventional electrode running roller.

FIG. 4 is a perspective view showing a state in which electrode running rollers are applied according to an embodiment of the present invention.

FIG. 5 is a front view showing a notching device including the electrode running rollers according to an embodiment of the present invention.

FIG. 6 is a graph showing measured maximum effective stresses of electrode running rollers of Examples 1 to 4 and Comparative Examples 1 to 3.

### BEST MODE

Hereinafter, the present invention will be described in detail based on the accompanying drawings so that a person having ordinary knowledge in the technical field to which the present invention belongs can easily carry it out. This invention may, however, be embodied in many different forms and is not limited to the embodiments set forth herein.

In order to clearly describe the present invention, parts irrelevant to the description are omitted, and the same or similar components are denoted by the same reference numerals throughout the specification.

Furthermore, terms or words used in the specification and claims should not be construed as being limited to its customary or dictionary meaning, and should be interpreted by the inventors as a meaning and concept consistent with the technical idea of the present invention, based on the principle that the concepts of the terms can be properly defined to describe their invention in the best possible manner.

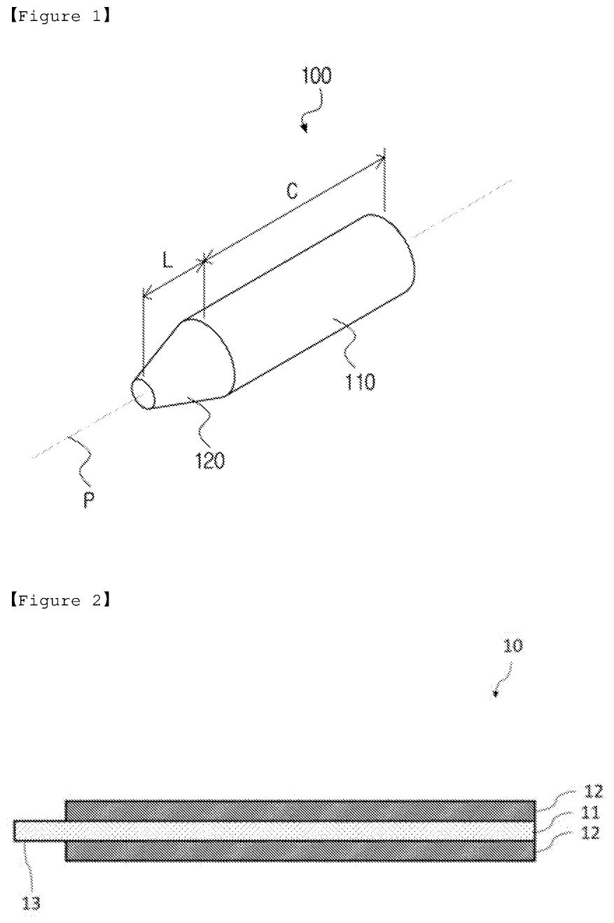

FIG. 1 is a perspective view showing an electrode running roller according to an embodiment of the present invention.

Referring to FIG. 1, an electrode running roller 100 according to an embodiment of the present invention is an electrode running roller 100 which causes an electrode sheet 10 in which a current collector 11 is coated with an electrode active material to run, and the running roller 100 includes a cylindrical section 110 and a tapered section 120 extending from one end portion of the cylindrical section 110. The tapered section 120 is configured such that the outer diameter gradually decreases toward the distal end portion of the tapered section 120.

Here, referring to FIG. 2, the electrode sheet 10 may include a coating portion 12 coated with an electrode active material on one side or both sides of a current collector 11 and a non-coating portion 13 not coated with the electrode active material.

Specifically, the coating portion 12 of the electrode sheet 10 may be continuously coated with the electrode active material along the running direction of the electrode running roller 100. Further, the non-coating portion 13 may not be coated with the electrode active material on the side portion in the running direction of the electrode running roller 100.

Further, in the electrode running roller 100, the non-coating portion 13 of the electrode sheet 10 may be disposed to be positioned in the tapered section 120 of the running roller 100.

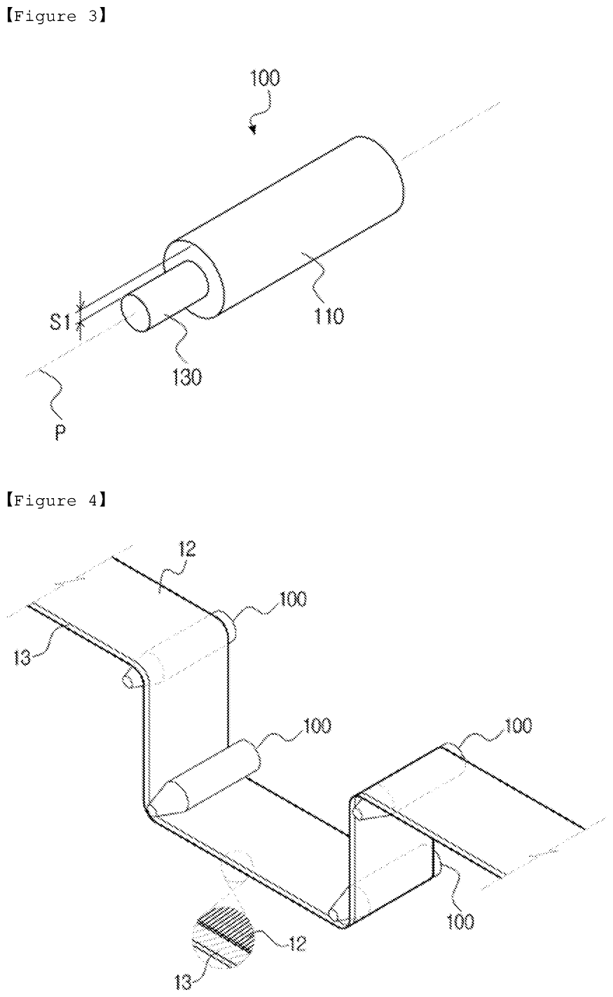

FIG. 3 is a perspective view showing an electrode running roller according to a conventional embodiment.

Referring to FIG. 3, the conventional electrode running roller 100 includes a cylindrical section 110 and a variable section 130 having a smaller diameter than the cylindrical section 110 so that a step S1 is formed on the outer peripheral surface of the cylindrical section.

At this time, the coating portion 12 of the electrode sheet 10 can be disposed at a position where it is in contact with the outer peripheral surface of the cylindrical section 110, and the non-coating portion 13 can be disposed to be positioned in the variable section 130 of the running roller 100. In addition, the boundary between the coating portion 12 and the non-coating portion 13 can be in contact with the outer peripheral surface of the cylindrical section 110. Therefore, when the electrode running roller 100 runs, because the cylindrical section 110 directly abuts on the boundary between the coating portion 12 and the non-coating portion 13 and acts as an external force, the effect of blocking and dispersing stress is minimal. Therefore, when the electrode sheet 10 is conveyed by the running roller 100, there is a problem that the electrode sheet 10 is broken.

Therefore, the present invention attempts to solve the above problem by providing the electrode running roller 100 comprising the tapered section 120 extending from one side end portion of the cylindrical section 110.

Hereinafter, the electrode running roller 100, which is an embodiment of the present invention, will be described in more detail with reference to FIG. 1.

In an embodiment of the invention, the ratio of the length (C) of the cylindrical section and the length (L) of the tapered section may be between 4:1 and 1:1, preferably between 3:2 and 7:3. Since it is possible to reduce the stress generated at the boundary between the coating portion 12 and the non-coating portion 13 of the electrode sheet 10. Within the above ratio range, occurrence of the breakage of the electrode sheet 10 can be prevented. Specifically, if the maximum effective stress generated at the boundary between the coating portion 12 and the non-coating portion 13 of the electrode sheet 10 is 50 MPa or more, the electrode sheet 10 may break. However, if the ratio of the length C of the cylindrical section to the length L of the tapered section is 4:1 to 1:1, the maximum effective stress generated at the boundary between the coating portion 12 and the non-coating portion 13 of the electrode sheet 10 is less than 50 MPa, and it is possible to solve the problem of breakage of the electrode sheet 10 accordingly. If the ratio of the length C of the cylindrical section to the length L of the tapered section is out of the range of 4:1 to 1:1, the stress is generated at 50 MPa or more, and the effect of improving the breakage problem generated in the electrode sheet 10 is low.

Also, in an embodiment of the present invention, the tapered section 120 may have a truncated conical shape, and may form an outer peripheral surface that is inclined at an angle of 0.2 to 0. 0.5 degrees, preferably, an angle of 0.25 to 0.35 degrees, toward the central axis P. In the above angle range, the contact between the non-coating portion 13 of the electrode sheet 10 and the tapered section 120 can be minimized, and the breakage of the electrode sheet 10 can be prevented.

FIG. 4 is a perspective view showing a state in which electrode running rollers according to an embodiment of the present invention are applied.

Referring to FIG. 4, in the electrode running roller 100 according to an embodiment of the present invention, the non-coating portion 13 of the electrode sheet 10 is positioned in the tapered section 120, and in the electrode running roller 100, the coating portion 12 of the electrode sheet 10 can be disposed at the boundary between the cylindrical section 110 and the tapered section 120. In addition, in the electrode sheet 10, the portion except for the non-coating portion 13 can be in contact with the outer peripheral surface of the cylindrical section 110.

Therefore, in the electrode running roller 100 according to the embodiment of the present invention configured as described above, by forming the tapered section 120 at one end portion of the cylindrical section 110 in which the electrode sheet 10 is in close contact with the outer peripheral surface when the electrode sheet 10 runs, since the portion of the electrode sheet 10 except for the non-coating portion 13 not coated with the electrode active material can be brought into close contact with the outer peripheral surface of the cylindrical section 110, it is possible to prevent breakage that occurs in the boundary between the non-coating portion 13 and the coating portion 12.

Hereinafter, a notching device according to an embodiment of the present invention will be described below.

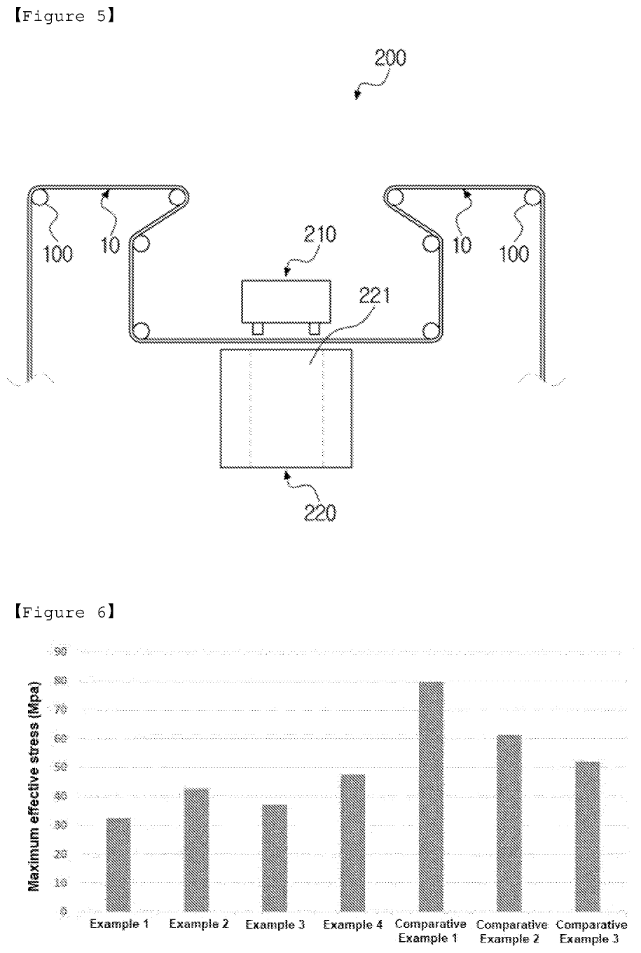

FIG. 5 is a front view showing a notching device comprising the electrode running rollers according to an embodiment of the present invention.

Referring to FIG. 5, a notching device 200 according to an embodiment of the present invention comprises electrode running rollers 100 which causes the electrode sheet 10 to run.

More specifically, the notching device 200 according to an embodiment of the present invention is made up of a press 210, a die 220 and an electrode running roller 100, and the continuous electrode sheet 10, in which the electrode active material is applied to one or both sides of a current collector, runs on the electrode running roller 100 of the notching device 200.

The press 210 punches the electrode sheet 10 at regular intervals so that electrode tabs are formed on the electrode sheet 10, and the electrode running roller 100 functions to convey the electrode sheet 10 by the press 210 in synchronization with the operation of the press 210.

Further, the die 220 is formed with an opening 221 having a shape corresponding to the press 210 so that scrap punched by the press 210 can be discharged.

The electrode running roller 100 is according to an embodiment of the present invention described above.

Hereinafter, preferred embodiments will be presented to aid understanding of the present invention, but the following examples are illustrative of the present invention, it is clear to those skilled in the art that various changes and modifications can be made within the scope and technical spirit of the present invention, and it goes without saying that such variations and modifications fall within the scope of the appended claims.

### Examples 1 to 4 and Comparative Examples 1 to 3. Manufacturing of Electrode Running Rollers

As shown in Table 1 below, the electrode running rollers of Examples 1 to 4 and Comparative Examples 2 to 3 having the ratio of the length C of the cylindrical section to the length L of the tapered section were manufactured.

Also, an electrode running roller of Comparative Example 1 comprising a variable section instead of a tapered section was manufactured.

TABLE 1

| | Length of cylindrical section: |
|---|---|
| | Length of tapered section |
| Example 1 | 7:3 |
| Example 2 | 1:1 |
| Example 3 | 3:2 |
| Example 4 | 4:1 |
| Comparative | 9:1 |
| example 2 | |
| Comparative | 2:3 |
| example 3 | |

### Test Example 1. Measurement of Maximum Effective Stress of Electrode Running Roller

When the electrode sheet was run using the electrode running rollers of Examples 1 to 4 and Comparative Examples 1 to 3, the maximum effective stress generated at the boundary between the non-coating portion and the coating portion of the electrode sheet was measured.

The maximum effective stress was measured using a flexible multi-body dynamics technique, which is a virtual verification model, and the measurement results were shown in Table 2 below.

TABLE 2

| | | | | | Comparative | Comparative | Comparative |
|---|---|---|---|---|---|---|---|
| | Example 1 | Example 2 | Example 3 | Example 4 | Example 1 | Example 2 | Example 3 |
| Maximum | 32.4 | 42.7 | 37.2 | 47.6 | 79.6 | 61.4 | 52.2 |
| effective | | | | | | | |
| stress (MPa) | | | | | | | |

If the stress is 50 MPa or more, the electrode sheet may break.

In the results of Table 2 above, the electrode running rollers of Examples 1 to 4 comprising the tapered section extending from one end portion of the cylindrical section showed a result that a maximum effective stress was less than 50 MPa. From this, it can be seen that the electrode running roller of the present invention can prevent breakage occurring in the electrode sheet and stably convey the electrode sheet.

In addition, Example 1 in which the ratio of the length of the cylindrical section to the length of the tapered section was 7:3 and Example 3 in which the ratio was 3:2 had the maximum effective stress lower than that of Examples 2 in which the ratio of the length of the cylindrical section to the length of the tapered section was 1:1 and Example 4 in which the ratio was 4:1. From the above results, it can also be seen that when the ratio of the length of the cylindrical section to the length of the tapered section is 3:2 to 7:3, it more preferable in view of preventing the breakage of the electrode sheet.

Comparative Example 1 is an electrode running roller comprising a variable section instead of a tapered section at one end portion of a cylindrical section, and shows that result that the maximum effective stress was 50 MPa or more due to the step between the cylindrical section and the tapered section. From this, it can be predicted that the electrode running roller of Comparative Example 1 cannot prevent breakage when conveying the electrode sheet.

In addition, in Comparative Examples 2 and 3, the ratio of the length the cylindrical section to the length of the tapered section does not fall within the range of 4:1 to 1:1, and showed a low maximum effective stress compared to Comparative Example 1 in which a step was formed, but shows the result more than 50 MPa. From the above results, only when the length ratio of the cylindrical section to the length of the tapered section is 4:1 to 1:1, the maximum effective stress is less than 50 MPa, and it is possible to understand that breakage occurring in the electrode sheet can be prevented.

### DESCRIPTION OF SYMBOLS

10: Electrode sheet,
11: Current collector
12: Coating portion,
13: Non-coating portion
100: Electrode running roller,
110: Cylindrical section
120: Tapered section,
130: Variable section
200: Notching device,
210: Press
220: Die,
221: Opening

1. An electrode running roller configured to move an electrode sheet in which a current collector is coated with an electrode active material, the electrode running roller comprising:
a cylindrical section; and
a tapered section extending from an end portion of the cylindrical section, the tapered section having a shape in which an outer diameter of the tapered section gradually decreases from the end portion of the cylindrical section toward a distal end portion of the tapered section.

2. The electrode running roller according to claim 1, wherein a ratio of a length of the cylindrical section to a length of the tapered section is 4:1 to 1:1.

3. The electrode running roller according to claim 1, wherein the tapered section has a truncated conical shape.

4. The electrode running roller according to claim 1, wherein the tapered section has an outer peripheral surface inclined at an angle of 0.2 to 0.5 degrees toward a central axis of the electrode running roller relative to an outer peripheral surface of the cylindrical section.

5. The electrode running roller according to claim 1, wherein the electrode sheet includes a coating portion coated with the electrode active material, and a non-coating portion not coated with the electrode active material, and the electrode running roller is configured to be disposed such that the non-coating portion of the electrode sheet is positioned adjacent to the tapered section of the electrode running roller.

6. The electrode running roller according to claim 5, wherein the electrode running roller is configured to be disposed such that the coating portion of the electrode sheet is positioned at a boundary between the cylindrical section and the tapered section.

7. The electrode running roller according to claim 5, wherein the electrode running roller is configured to be disposed such that a portion of the electrode sheet, outside of the non-coating portion, is in contact with an outer peripheral surface of the cylindrical section.

8. A notching device configured to form an electrode tab on a continuous electrode sheet in which an electrode active material is coated on one or two sides of a current collector in a manufacturing process of a battery cell, the notching device comprising:
a press configured to punch the electrode sheet so that the electrode tab is formed on a part of the electrode sheet;
a die having an opening having a shape conforming to a shape of the press, the opening configured to receive a discharge therethrough of a scrap punched by the press; and
the electrode running roller according to claim 1, the electrode running roller configured to convey the electrode sheet to the press in synchronization with operation of the press.

9. A method of moving an electrode sheet with an electrode running roller, the electrode sheet including a current collector coated with an electrode active material, the method comprising:
moving the electrode sheet with the electrode running roller, the electrode running roller having a cylindrical section and a tapered section extending from an end portion of the cylindrical section, the tapered section having a shape in which an outer diameter of the tapered section gradually decreases from the end portion of the cylindrical section toward a distal end portion of the tapered section.

10. The method according to claim 9, wherein a ratio of a length of the cylindrical section to a length of the tapered section is 4:1 to 1:1.

11. The method according to claim 9, wherein the tapered section has a truncated conical shape.

12. The method according to claim 9, wherein the tapered section has an outer peripheral surface inclined at an angle of 0.2 to 0.5 degrees toward a central axis of the electrode running roller relative to an outer peripheral surface of the cylindrical section.

13. The method according to claim 9, wherein the electrode sheet includes a coating portion coated with the electrode active material, and a non-coating portion not coated with the electrode active material, and
wherein during the moving, the non-coating portion of the electrode sheet is positioned adjacent to the tapered section of the electrode running roller.

14. The method according to claim 13, wherein during the moving, the coating portion of the electrode sheet is positioned at a boundary between the cylindrical section and the tapered section of the electrode running roller.

15. The method according to claim 13, wherein during the moving, a portion of the electrode sheet, outside of the non-coating portion, is in contact with an outer peripheral surface of the cylindrical section of the electrode running roller.
